(19) United States
(12) Patent Application Publication
(10) Pub. No.: US 2019/0278283 A1
(43) Pub. Date: Sep. 12, 2019

(54) DEVICE, SYSTEM AND METHOD FOR VEHICLE DRIVING ASSISTANCE

(71) Applicant: BOE TECHNOLOGY GROUP CO., LTD., Beijing (CN)

(72) Inventors: Shuping Gai, Beijing (CN); Xiao Zhang, Beijing (CN); Changlin Leng, Beijing (CN)

(21) Appl. No.: 16/136,156

(22) Filed: Sep. 19, 2018

(30) Foreign Application Priority Data
Mar. 12, 2018 (CN) 201810200654.7

(51) Int. Cl. G05D 1/02; B60W 40/06; B60W 30/10

(52) U.S. Cl. CPC G05D 1/0221; B60W 40/06; B60W 40/04; G05D 1/0238; B60W 30/10

(57) ABSTRACT

A vehicle driving assistance device is disclosed, including: a sensor system, configured to sense current traveling state information of a vehicle and surrounding environment information of an area in which the vehicle is located; a communication circuit, configured to acquire a driving model of successfully passing through the area; and a data processor, configured to provide vehicle traveling information on a subsequent vehicle traveling operation according to the acquired driving model, the current traveling state information of the vehicle, and the surrounding environment information. A system including a vehicle driving assistance device and a cloud server, and a method for vehicle driving assistance are also disclosed. The vehicle driving assistance device transmits the driving model to the cloud server, or acquires the driving model from the cloud server.

### CROSS-REFERENCE TO RELATED APPLICATION(S)

This application claims priority to Chinese Application No. 201810200654.7, entitled “DEVICE, SYSTEM AND METHOD FOR VEHICLE DRIVING ASSISTANCE” and filed on Mar. 12, 2018, which is incorporated herein by reference in its entirety.

### TECHNICAL FIELD

The present disclosure relates to the field of vehicle networking technology, and in particular to a device, a system and a method for vehicle driving assistance.

### BACKGROUND

With development of technology, various technologies have emerged to assist people in driving vehicles, and even an automatic driving technology has emerged. According to the implemented technology, when driving the vehicle, the driver may be provided with various auxiliary information, so that the driver may e.g., pre-judge a road ahead, know a place to be entered, etc., thereby making a decision on subsequent driving operations as needed.

### SUMMARY

According to a first aspect of the present disclosure, the present disclosure provides a vehicle driving assistance device. The vehicle driving assistance device includes:

a sensor system configured to sense current traveling state information of a vehicle and surrounding environment information of an area in which the vehicle is located;

a communication circuit configured to acquire a driving model for successfully passing through the area; and

a data processor configured to provide vehicle traveling information on a subsequent vehicle traveling operation according to the acquired driving model, the current traveling state information of the vehicle, and the surrounding environment information.

According to an embodiment of the present disclosure, the driving model includes at least information about one of a vehicle speed, a manipulation manner or a lane track when the vehicle successfully passes through the area.

According to an embodiment of the present disclosure, the vehicle driving assistance device further includes: a memory for storing the driving model for the vehicle successfully passing through the area.

According to an embodiment of the present disclosure, the data processor is further configured to train the stored driving model as a sample to obtain an optimal driving model for passing through the area and store the optimal driving model in the memory.

According to an embodiment of the present disclosure, the communication circuit is configured to acquire the driving model from a cloud server.

According to an embodiment of the present disclosure, the communication circuit is further configured to transmit to the cloud server the driving model for the vehicle successfully passing through the area.

According to an embodiment of the present disclosure, the vehicle driving assistance device further includes a controller for controlling the vehicle according to the vehicle traveling information provided from the data processor when the vehicle is in an automatic driving mode.

According to an embodiment of the present disclosure, the area includes an underground garage or a narrow road.

According to an embodiment of the present disclosure, the vehicle traveling information includes at least a predicted route and a vehicle body track.

According to an embodiment of the present disclosure, the sensor system includes at least one of a camera, radar or an infrared sensing apparatus.

According to a second aspect of the present disclosure, a vehicle driving assistance system is provided. The vehicle driving assistance system includes:

the vehicle driving assistance device as described above; and

a cloud server for transmitting the driving model to the vehicle in response to a request of the vehicle for the driving model.

According to a third aspect of the present disclosure, a vehicle driving assistance method is provided. The vehicle driving assistance method includes:

sensing current traveling state information of a vehicle and surrounding environment information of an area in which the vehicle is located;

acquiring a driving model for successfully passing through the area; and

providing vehicle traveling information on a subsequent vehicle traveling operation according to the acquired driving model, the current traveling state information of the vehicle, and the surrounding environment information.

According to an embodiment of the present disclosure, the driving model includes at least information about one of a vehicle speed, a manipulation manner or a lane track when the vehicle successfully passes through the area.

According to an embodiment of the present disclosure, the vehicle driving assistance method further includes:

controlling the vehicle according to the vehicle traveling information when the vehicle is in an automatic driving mode.

According to an embodiment of the present disclosure, the vehicle driving assistance method further includes: storing the driving model for the vehicle successfully passing through the area.

According to an embodiment of the present disclosure, the vehicle driving assistance method further includes:

training the stored driving model as a sample to obtain an optimal driving model for passing through the area and storing the optimal driving model.

According to an embodiment of the present disclosure, acquiring the driving model for successfully passing through the area includes: acquiring the driving model from a cloud server.

According to an embodiment of the present disclosure, the vehicle driving assistance method further includes:

transmitting to a cloud server the driving model for the vehicle successfully passing through the area.

According to an embodiment of the present disclosure, the area includes an underground garage or a narrow road.

### BRIEF DESCRIPTION OF THE DRAWINGS

The particular embodiments of the present disclosure will be further described below in detail with reference to the accompanying drawings:

FIG. 1 is a schematic diagram of a vehicle driving assistance system according to an embodiment of the present disclosure; and

FIG. 2 is a flowchart of a vehicle driving assistance method according to an embodiment of the present disclosure.

### DETAILED DESCRIPTION

In order to explain the present disclosure more clearly, the present disclosure will be further described in conjunction with the preferred embodiments and the accompanying drawings. Similar elements in the drawings are denoted by the same reference numerals. The skilled in the art should understand that the following detailed description is not intended to limit the scope of the disclosure.

Currently, there are a lot of hidden dangers for drivers, such as close side walls and ground rods on lanes, at entrances and exits of underground garages in many circumstances, such as communities, shopping malls and supermarkets, since the lanes are narrow, in and out frequencies of vehicles are relatively high, and many new drivers are unskilled, etc. Thus, the entrances and exits of the underground garages are dangerous driving areas, greatly increasing difficulty of using the underground garage and lowering user experience.

According to the device, the system and the method for vehicle driving assistance according to the present disclosure, when the vehicle passes through an area, such as an underground garage or a narrow road, the vehicle (specifically, the driver of the vehicle) may be provided with assistance information according to a driving model for a vehicle (specifically, the vehicle or other vehicles) successfully passing through the area, in order to help the vehicle (specifically, the driver of the vehicle) successfully pass through the area.

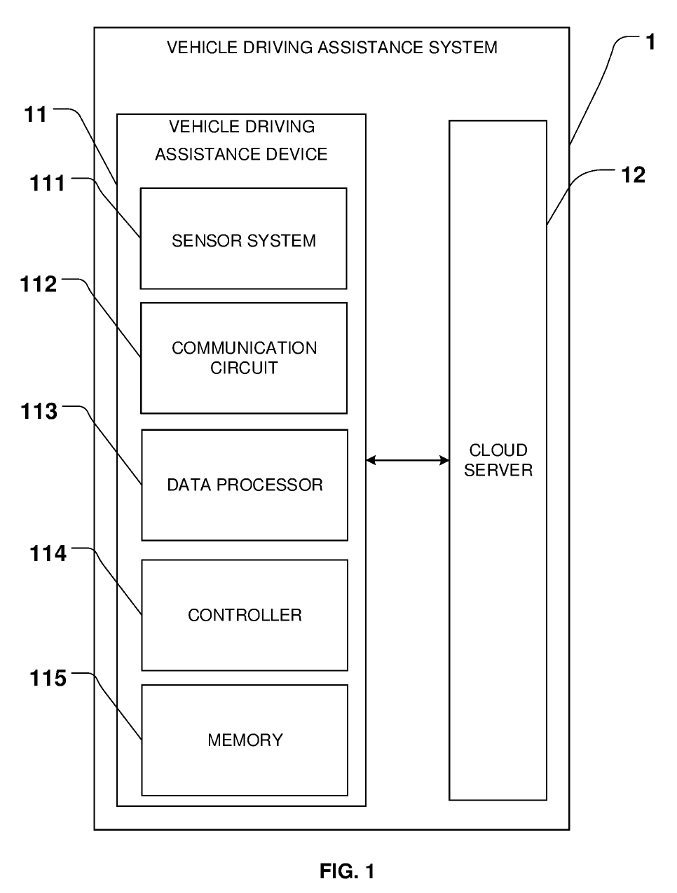

As shown in FIG. 1, a vehicle driving assistance device 11 according to an embodiment of the present disclosure is particularly suitable for use when a vehicle enters or exits an underground garage or passes through a narrow road. The vehicle driving assistance device 11 includes:

a sensor system 111 configured to sense current traveling state information of a vehicle and surrounding environment information of an area in which the vehicle is located;

a communication circuit 112, configured to acquire a driving model for successfully passing through the area; and

a data processor 113, configured to provide vehicle traveling information on a subsequent vehicle traveling operation according to the acquired driving model, the current traveling state information of the vehicle, and the surrounding environment information.

In an embodiment, the driving model includes at least information about one of a vehicle speed, a manipulation manner or a lane track when the vehicle successfully passes through the area.

The vehicle traveling information according to an embodiment of the present disclosure may include at least a predicted route and a vehicle body track. For example, the vehicle driving assistance device according to an embodiment of the present disclosure may include a speaker, which generates audio information to prompt the driver, such as “Turn Left Ahead”, according to the vehicle traveling information provided from the data processor. Alternatively, the vehicle driving assistance device according to an embodiment of the present disclosure may further include a display, which displays the predicted route and/or the vehicle body track on the display according to the vehicle traveling information provided from the data processor.

The sensor system 111 according to an embodiment of the present disclosure may include at least one of a camera, radar, or an infrared sensing apparatus. The camera uses the machine vision technology to obtain a position image of the surroundings of the vehicle. The radar determines a distance between the vehicle and a surrounding obstacle by emitting and receiving ultrasonic waves in real time. The infrared sensing apparatus may sense whether there is an obstacle around the vehicle. The data processor 113 may prompt the user a driving track ahead of the vehicle based on information from the sensor system, so as to assist the driver to drive the vehicle into the garage. Alternatively, the smart driving assistance device 11 may include an anti-collision warning system. The anti-collision warning system includes ultrasonic radar, and measures a distance between the vehicle and the lane with ultrasonic radar ranging technique. The ultrasonic radar accurately measures a delay time from a moment of emitting the ultrasonic wave to a moment of receiving its echo. This delay time is a propagation time of the wave emitted from the transmitter to a target (the lane wall or obstacle) and then back to the ultrasonic radar receiver from the target. According to a propagation speed of the ultrasonic wave, the distance from the target may be determined as: S=CT/2, where S is the distance from the target, T is a time period from emitting the ultrasonic wave from the radar to receiving the echo from the target, and C is an ultrasonic speed.

The data processor 113 includes a CPU, an arithmetic circuit, and the like. The CPU receives the surrounding environment information of the vehicle acquired by the camera and the ultrasonic radar; calculates and determines a traveling speed and a traveling direction of the vehicle; calculates a distance threshold between the vehicle and the surrounding obstacle as required for safe traveling of the vehicle according to the distance between the vehicle and the surrounding obstacle during traveling and the current vehicle speed; and controls an onboard video system (e.g., a display) or an audio system (e.g., a speaker) to inform the user to take an immediate action when the distance between the vehicle and the obstacle approaches to the threshold.

The vehicle driving assistance device 11 according to an embodiment of the present disclosure may further include a controller 114. If the user selects an automatic driving mode, that is, the vehicle is in the automatic driving mode, the controller 114 controls the vehicle according to the vehicle traveling information provided from the data processor, automatically controlling a steering wheel to adjust the traveling direction of the vehicle to ensure that the vehicle enters and exits the garage safely.

The vehicle driving assistance device 11 according to an embodiment of the present disclosure may further include a memory 115 for storing the driving model for the vehicle successfully passing through the area. When it is detected that the vehicle passes through a certain area (for example, an underground garage) in a non-automatic driving mode, e.g., an assisted driving mode, the memory takes the current process of successfully driving into or out of the underground garage as a driving model 1, storing information about a real-time vehicle speed, a traveling direction, a lane track etc. as recorded by the sensor system 11 for later usage. For example, when a driver drives a car to successfully pass through an area with the vehicle traveling information, the driving model for him/her successfully passing through the area may be stored in the memory as a driving model for successfully passing through the area, which may be useful for another driver to pass through the same area or for another car to pass through the same area in an automatic driving mode. Here, Sample 1 is the optimal driving model.

When the vehicle enters again the underground garage that it has passed, if the driver does not select to invoke the driving model but selects a manual driving mode and finally successfully passes through the underground garage, the memory 115 records again the information about the real-time vehicle speed, the traveling direction, the lane track etc. of the vehicle in the process of the driver successfully driving in or out of the underground garage this time, and information on obstacles in the area, as a driving model 2. According to an embodiment of the present disclosure, the driver may also select whether to update the driving model using the current driving model.

The data processor according to an embodiment of the present disclosure may also be configured to train the stored driving model as a sample to obtain an optimal driving model for passing through the area, and store the optimal driving model in the memory. Subsequently, when the vehicle enters the underground garage, the vehicle traveling information on the traveling operation of the vehicle may be obtained by referring to the optimal driving model.

When the vehicle enters again the underground garage that it has passed, the user may select to invoke the stored (optimal) driving model. If the user selects the assisted driving mode, the controller 114 directs the user to drive the vehicle by outputting the vehicle traveling information provided by the data processor, according to the invoked driving model. When the user selects the automatic driving mode, the controller 114 controls the vehicle according to the vehicle traveling information provided by the data processor.

According to an embodiment of the present disclosure, the controller 114 may include an OBD (On-Board Diagnostic) system for acquiring traveling state information of the vehicle in real time, including the vehicle speed and the traveling direction, and for reminding or controlling to change the traveling state of the vehicle in real time in conjunction with the position of the vehicle.

According to an embodiment of the present disclosure, the communication circuit 112 may be a communication circuit within the vehicle driving assistance device for e.g., acquiring the driving model from the memory 115 and transmitting it to the data processor, or may be a communication circuit, such as a wireless transceiver, for the vehicle driving assistance device to communicate with the external for e.g. acquiring the driving model from a cloud server.

According to an embodiment of the present disclosure, the communication circuit 112 may be further configured to transmit to the cloud server the driving model for the vehicle successfully passing through the area in a non-automatic driving mode, e.g., an assisted driving mode. For example, when a driver drives a car to successfully pass through an area with the vehicle traveling information, the driving model for him/her successfully passing through the area may be transmitted to the cloud server as a driving model for successfully passing through the area, which may be useful for another driver to pass through the same area or for another car to pass through the same area in an automatic driving mode.

Another embodiment of the present disclosure provides a vehicle driving assistance system including the vehicle driving assistance device 11 and the cloud server 12 as described in the above embodiments. When the vehicle is passing through a predetermined area (e.g., an underground garage), the vehicle driving assistance device 11 transmits a request for the driving model of the predetermined area to the cloud server 12. In response to the request, the cloud server 12 transmits the corresponding (optimal) driving model to the vehicle driving assistance device 11.

The user may upload his or her (optimal) driving model to the cloud server 12 by the vehicle driving assistance device 11. The cloud server 12 may train the driving models uploaded by at least one user to calculate and optimize the samples to obtain an optimal driving model.

The user may download the optimal driving model from the cloud server 12, and store it in the memory, so as to allow the vehicle to be driven automatically when needed. The vehicle may be driven into or out of the underground garage automatically according to the obtained optimal driving model.

The vehicle driving assistance system according to an embodiment of the present disclosure may also interconnect all the vehicles using the system by the vehicle networking technology. When the user needs to drive the vehicle into an unknown underground parking garage, a recommended driving model for entering and exiting the garage may be obtained by the cloud server 12 of the system. According to the information such as the vehicle condition, the distance between the position of the surrounding obstacle and the vehicle position, or referring to the obtained optimal driving model, the system may use e.g. the machine vision method to prompt the driving track, direct the driver to perform the driving operation, such as the rotation angle of the steering wheel, the traveling speed, in real time via a central control display screen. The recommended driving model is obtained by storing the optimal driving models of other vehicles entering the garage in a sample library, calculating and comparing parameter information of the respective driving models in the sample library, learning and reorganizing a knowledge structure, so that the performance of the optimal driving model is continuously Improved, and finally the recommended driving model is obtained. The recommended driving model may be obtained by using a machine learning algorithm. The user may also upload his or her own driving model after successfully entering the garage, so as to update the sample library of the cloud server 12; at the same time, the user may evaluate the driving model downloaded from the cloud server 12 and used. The cloud server 12 may record an evaluation result of the user, use the reinforced learning technology to sort all the driving models in a sample library according to the evaluation result, and arrange the driving model with a better evaluation result in a front position. When another vehicle needs to download the corresponding driving model, the cloud server 12 preferentially recommends the driving model arranged in the front position to the user for reference by the other vehicle.

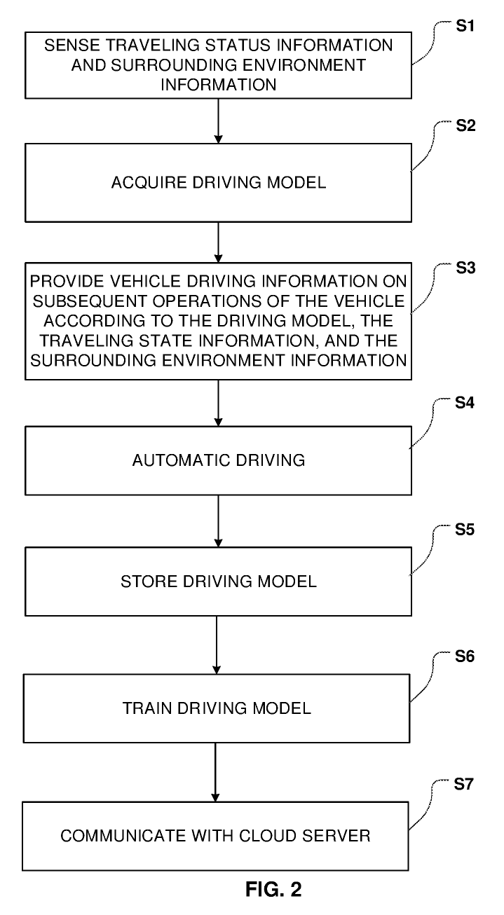

An embodiment of the present disclosure further provides a vehicle driving assistance method. As shown in FIG. 2, the vehicle driving assistance method includes:

S1: sensing current traveling state information of a vehicle and surrounding environment information of an area in which the vehicle is located.

The traveling state information of the vehicle and surrounding environment information may be sensed by e.g. a camera, radar or an infrared sensing apparatus. The camera uses the machine vision technology to obtain the surrounding environment information of the vehicle. The radar determines the distance between the vehicle and the surrounding obstacle by emitting and receiving the ultrasonic waves in real time. The infrared sensing apparatus may sense whether there is an obstacle around the vehicle.

S2: acquiring a driving model for successfully passing through the area.

S3: providing vehicle traveling information on a subsequent vehicle traveling operation according to the acquired driving model, the current traveling state information of the vehicle, and the surrounding environment information.

For example, the traveling speed and the traveling direction of the vehicle may be calculated and determined according to the surrounding environment information of the vehicle acquired by the camera and the ultrasonic radar. The distance threshold between the vehicle and the surrounding obstacle as required for safe traveling of the vehicle may be calculated according to the distance between the vehicle and the surrounding obstacle during traveling and the current vehicle speed. When the distance between the vehicle and the obstacle approaches to the threshold, the user is notified of taking an immediate action by audio or video.

The vehicle driving assistance method according to an embodiment of the present disclosure may further include step S4, in which if the user selects the automatic driving mode, the vehicle is controlled according to the provided vehicle traveling information, e.g., the steering wheel is automatically controlled to adjust the traveling direction of the vehicle to ensure that the vehicle enters and exits the garage safely.

The vehicle driving assistance method according to an embodiment of the present disclosure may further include step S5, in which the driving model for the vehicle successfully passing through the area in the assist driving mode is stored. When it is detected that the vehicle passes through a certain area (for example, an underground garage) in a non-automatic driving mode, the current process of successfully driving into or out of the underground garage is taken as the driving model 1, storing information about a real-time vehicle speed, a traveling direction, a lane track etc. as recorded by the sensor system 11. Here, driving model 1 is the optimal driving model.

When the vehicle enters again the underground garage that it has passed, if the user does not select to invoke the driving model but selects a manual driving mode and finally successfully passes through the underground garage, the information about the real-time vehicle speed, the traveling direction, the lane track etc. of the vehicle in the process of the driver successfully driving in or out of the underground garage this time, and information on obstacles in the area are stored as the driving model 2. According to an embodiment of the present disclosure, the user may also select whether to update the driving model using the current driving model.

The vehicle driving assistance method according to an embodiment of the present disclosure may further include step S6, in which the stored driving model is trained as a sample to obtain the optimal driving model for passing through the area, and the optimal driving model is stored. Subsequently, when the vehicle enters the underground garage, the vehicle traveling information on the traveling operation of the vehicle may be obtained by referring to the optimal driving model.

The vehicle driving assistance method according to an embodiment of the present disclosure may further include step S7, in which the user may upload his or her optimal driving model to the cloud server 12 or download a successful driving model of other vehicles from the cloud server 12 by the vehicle driving assistance device.

The vehicle driving assistance system according to the present disclosure uses various sensors to detect the traveling path of the vehicle, and utilizes a plurality of kinds of sensing units, such as the camera, radar, and infrared sensing apparatus, to obtain information about the driving environment, moving speed, and moving track of the vehicle. Smart assisted driving and automatic driving may be realized in special driving scenes with hidden dangers, such as a narrow lane or an underground garage by providing the predicted route and the vehicle body track, which is especially convenient for new users to drive the vehicle into or out of the garage.

It is apparent that the above-described embodiments of the present disclosure are merely illustrative, and are not intended to limit the embodiments of the present disclosure. The skilled in the art may also make various different modification or variations based on the above description, which will not be exhausted herein. It is to be understood that various changes and modifications fall into the spirit and the scope of the present disclosure.

I/We claim:

1. A vehicle driving assistance device, comprising:
a sensor system configured to sense current traveling state information of a vehicle and surrounding environment information of an area in which the vehicle is located;
a communication circuit configured to acquire a driving model for successfully passing through the area; and
a data processor configured to provide vehicle traveling information on a subsequent vehicle traveling operation according to the acquired driving model, the current traveling state information of the vehicle, and the surrounding environment information.

2. The vehicle driving assistance device according to claim 1, wherein the driving model comprises at least information about one of a vehicle speed, a manipulation manner or a lane track when the vehicle successfully passes through the area.

3. The vehicle driving assistance device according to claim 1, further comprising: a memory configured to store the driving model for the vehicle successfully passing through the area.

4. The vehicle driving assistance device according to claim 3, wherein the data processor is further configured to train the stored driving model as a sample to obtain an optimal driving model for passing through the area and store the optimal driving model in the memory.

5. The vehicle driving assistance device according to claim 1, wherein the communication circuit is configured to acquire the driving model from a cloud server.

6. The vehicle driving assistance device according to claim 5, wherein the communication circuit is further configured to transmit to the cloud server the driving model for the vehicle successfully passing through the area.

7. The vehicle driving assistance device according to claim 4, further comprising a controller configured to control the vehicle according to the vehicle traveling information provided by the data processor when the vehicle is in an automatic driving mode.

8. The vehicle driving assistance device according to claim 1, wherein the area comprises an underground garage or a narrow road.

9. The vehicle driving assistance device according to claim 1, wherein the vehicle traveling information comprises at least a predicted route and a vehicle body track.

10. The vehicle driving assistance device according to claim 1, wherein the sensor system comprises a camera, radar, and/or an infrared sensing apparatus.

11. A vehicle driving assistance system, comprising:
the vehicle driving assistance device according to claim 1; and
a cloud server for transmitting the driving model to the vehicle in response to a request of the vehicle for the driving model.

12. The vehicle driving assistance system according to claim 11, wherein the cloud server is configured to train the stored driving model as the sample to obtain the optimal driving model for passing through the area.

13. A vehicle driving assistance method, comprising:
sensing current traveling state information of a vehicle and surrounding environment information of an area in which the vehicle is located;
acquiring a driving model for successfully passing through the area; and
providing vehicle traveling information on a subsequent vehicle traveling operation according to the acquired driving model, the current traveling state information of the vehicle, and the surrounding environment information.

14. The vehicle driving assistance method according to claim 13, wherein the driving model comprises at least information about one of a vehicle speed, a manipulation manner or a lane track when the vehicle successfully passes through the area.

15. The vehicle driving assistance method according to claim 13, further comprising:
controlling the vehicle according to the vehicle traveling information when the vehicle is in an automatic driving mode.

16. The vehicle driving assistance method according to claim 13, further comprising:
storing the driving model for the vehicle successfully passing through the area.

17. The vehicle driving assistance method according to claim 16, further comprising:
training the stored driving model as a sample to obtain an optimal driving model for passing through the area and storing the optimal driving model.

18. The vehicle driving assistance method according to claim 13, wherein acquiring the driving model for successfully passing through the area comprises: acquiring the driving model from a cloud server.

19. The vehicle driving assistance method according to claim 18, further comprising:
transmitting to the cloud server the driving model for the vehicle successfully passing through the area.

20. The vehicle driving assistance method according to claim 13, wherein the area comprises an underground garage or a narrow road.
